(19) United States
(12) Patent Application Publication
(10) Pub. No.: US 2025/0173392 A1
(43) Pub. Date: May 29, 2025

(54) SYSTEM AND METHOD FOR INFERENCE OF AI MODELS

(71) Applicant: Samsung Electronics Co., Ltd., Suwon-si (KR)

(72) Inventors: Chiho CHOI, San Jose, CA (US); Sangmin YOO, Ann Arbor, MI (US); Soon Ju KIM, San Jose, CA (US); Srikanth MALLA, Sunnyvale, CA (US); Joon Hee CHOI, Campbell, CA (US)

(21) Appl. No.: 18/778,909

(22) Filed: Jul. 19, 2024

Related U.S. Application Data
(60) Provisional application No. 63/604,170, filed on Nov. 29, 2023.
(60) Provisional application No. 63/562,695, filed on Mar. 7, 2024.

(51) Int. Cl. G06F 17/16; G06F 7/02

(52) U.S. Cl. CPC G06F 17/16; G06F 7/02

(57) ABSTRACT

A processor is disclosed. A first processing layer of the processor may process a first vector into a second vector. A second processing layer may process the second vector into a third vector. A comparator to determine a similarity of the third vector and a fourth vector. A refine module may refine the third vector into a fifth vector based at least in part on the similarity of the third vector and the fourth vector.

### RELATED APPLICATION DATA

This application claims the benefit of U.S. Provisional Patent Application Ser. No. 63/604,170, filed Nov. 29, 2023, and of U.S. Provisional Patent Application Ser. No. 63/562,695, filed Mar. 7, 2024, both of which are incorporated by reference herein for all purposes.

### FIELD

The disclosure relates generally to processing data, and more particularly to processing data iteratively more efficiently.

### BACKGROUND

The use of Artificial Intelligence (AI) has grown significantly of late. Processing data using AI—for example, natural language processing—may involve iterative processing of tokens using a number of layers, which is fixed in advance. The amount of processing performed to complete all the layers in the process may be significant.

A need remains to support more efficient data processing.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine including an Artificial Intelligence (AI) processor, according to embodiments of the disclosure.

FIG. 2 shows details of the machine of FIG. 1, according to embodiments of the disclosure.

FIG. 3 shows details of the AI processor of FIG. 1, according to embodiments of the disclosure.

FIG. 4 shows details of the layers of FIG. 3, according to embodiments of the disclosure.

FIG. 5 shows an example of how the use of the AI processor of FIG. 1 may be subject to early exit, according to embodiments of the disclosure.

FIG. 6 shows how the initial vector may be generated from the input token of FIG. 3, according to embodiments of the disclosure.

FIG. 7 shows details of the comparator of FIG. 3, according to embodiments of the disclosure.

FIG. 8 shows details of the refine module of FIG. 3, according to embodiments of the disclosure.

FIG. 9 shows a flowchart of an example procedure for the AI processor of FIG. 1 to process data, according to embodiments of the disclosure.

FIG. 10 shows a flowchart of an example procedure for the comparator of FIG. 3 determine the similarity of two vectors of FIG. 5, according to embodiments of the disclosure.

FIG. 11 shows a flowchart of an example procedure for the refine module of FIG. 3 approximate the final output of layers of FIG. 3, according to embodiments of the disclosure.

FIG. 12 shows a flowchart of an example procedure for the AI processor of FIG. 1 to begin processing the input token of FIG. 3, according to embodiments of the disclosure.

FIG. 13 shows a flowchart of an example procedure for the AI processor of FIG. 1 to generate the output token of FIG. 3, according to embodiments of the disclosure.

FIG. 14A shows a flowchart of an example procedure for the AI processor of FIG. 1 to process data, according to embodiments of the disclosure.

FIG. 14B continues the flowchart of FIG. 14A of an example procedure for the AI processor of FIG. 1 to process data, according to embodiments of the disclosure.

FIG. 14C continues the flowchart of FIG. 14B of an example procedure for the AI processor of FIG. 1 to process data, according to embodiments of the disclosure.

### SUMMARY

Between layers in an Artificial Intelligence (AI) processor, a similarity of two vectors may be determined. If the vectors are sufficiently similar, the AI processor may undergo early exit from the processing of a token.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

As the use of Artificial Intelligence (AI) grows, so does the amount of processing to be performed. Neural networks that process data using AI typically use an iterative process involving a number of layers that are similar, but not necessarily identical: for example, 96 layers. The number of layers may be fixed: all tokens may be processed using the same number of layers. A token may be input at the start, the various layers may transform the token iteratively, and the output may be the final token that is the result.

To complete processing, all the layers may be processed. To process a token using all 96 layers may involve a significant amount of computing, and may take a relatively large amount of time. Thus, to process the data fully might require more time or power than is considered desirable.

The number of layers may be reduced, to expedite overall processing and reduce power consumption. But reducing the number of layers may result in the output being less accurate, and possibly incorrect (or more incorrect) relative using all 96 layers. For example, some tokens might require more layers to produce an accurate result, and expediting processing by reducing the number of layers might mean that tokens that require additional processing may not be accurately processed.

Embodiments of the disclosure address these problems by introducing logic to short-circuit processing of tokens in the layers. The results of two consecutive layers may be compared: if the result is sufficiently similar, it may be concluded that further processing using the layers is unlikely to significantly alter the result, and processing may be exited early. One last refine module may then be used to approximate the remaining processing that might otherwise be performed by the unused layers in the neural network.

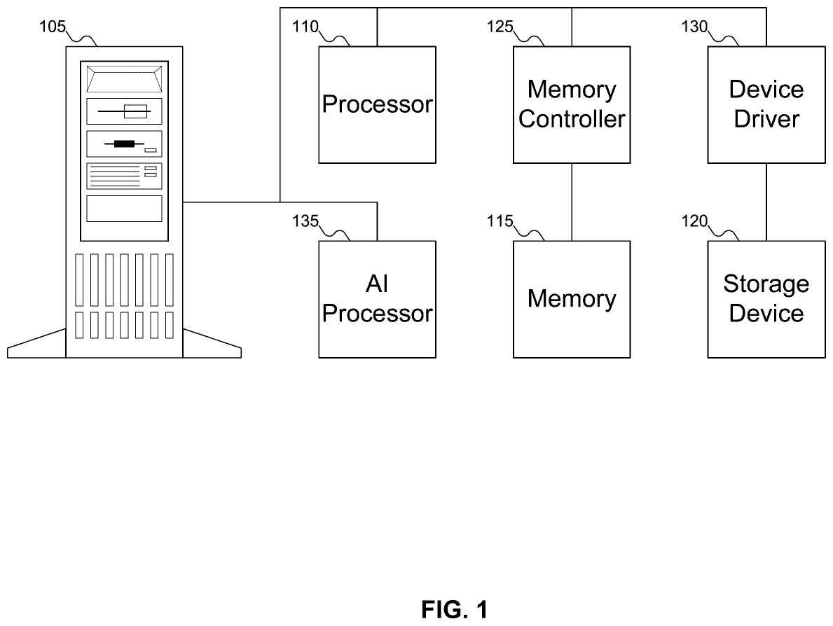

FIG. 1 shows a machine including an Artificial Intelligence (AI) processor, according to embodiments of the disclosure. In FIG. 1, machine 105, which may also be termed a host or a system, may include processor 110, memory 115, and storage device 120.

Processor 110 may be any variety of processor. (Processor 110, along with the other components discussed below, are shown outside the machine for ease of illustration: embodiments of the disclosure may include these components within the machine.) While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115, which may also be referred to as a main memory, may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120. Storage device 120 may be accessed using device driver 130.

Storage device 120 may be associated with an accelerator (not shown in FIG. 1), which may also be referred to as a computational storage device, computational storage unit, computational storage device, or computational device. Storage device 120 and the accelerator may be designed and manufactured as a single integrated unit, or the accelerator may be separate from storage device 120. The phrase “associated with” is intended to cover both a single integrated unit including both a storage device and an accelerator and a storage device that is paired with an accelerator but that are not manufactured as a single integrated unit. In other words, a storage device and an accelerator may be said to be “paired” when they are physically separate devices but are connected in a manner that enables them to communicate with each other. Further, in the remainder of this document, any reference to storage device 120 may be understood to refer to the devices either as physically separate but paired (and therefore may include the other device) or to both devices integrated into a single component as a computational storage unit.

In addition, the connection between the storage device and the paired accelerator might enable the two devices to communicate, but might not enable one (or both) devices to work with a different partner: that is, the storage device might not be able to communicate with another accelerator, and/or the accelerator might not be able to communicate with another storage device. For example, the storage device and the paired accelerator might be connected serially (in either order) to the fabric, enabling the accelerator to access information from the storage device in a manner another accelerator might not be able to achieve.

While FIG. 1 uses the generic term “storage device”, embodiments of the disclosure may include any storage device formats that may be associated with computational storage, examples of which may include hard disk drives and Solid State Drives (SSDs). Any reference to a specific type of storage device, such as an “SSD”, below should be understood to include such other embodiments of the disclosure.

Processor 105 and storage device 120 may communicate across a fabric (not shown in FIG. 1). This fabric may be any fabric along which information may be passed. Such fabrics may include fabrics that may be internal to machine 105, and which may use interfaces such as Peripheral Component Interconnect Express (PCIe), Serial AT Attachment (SATA), or Small Computer Systems Interface (SCSI), among others. Such fabrics may also include fabrics that may be external to machine 105, and which may use interfaces such as Ethernet, Infiniband, or Fibre Channel, among others. In addition, such fabrics may support one or more protocols, such as Non-Volatile Memory Express (NVMe), NVMe over Fabrics (NVMe-oF), Simple Service Discovery Protocol (SSDP), or a cache-coherent interconnect protocol, such as the Compute Express Link® (CXL®) protocol, among others. (Compute Express Link and CXL are registered trademarks of the Compute Express Link Consortium in the United States.) Thus, such fabrics may be thought of as encompassing both internal and external networking connections, over which commands may be sent, either directly or indirectly, to storage device 120. In embodiments of the disclosure where such fabrics support external networking connections, storage device 120 might be located external to machine 105, and storage device 120 might receive requests from a processor remote from machine 105.

FIG. 1 also shows Artificial Intelligence (AI) processor 135. Like processor 105, AI processor 135 may implement a Reduced Instruction Set Computer (RISC) architecture or a Complex Instruction Set Computer (CISC) architecture (among other possibilities), and may be implemented using a Central Processing Unit (CPU), a Field Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU), but often may implement a neural network. AI processor 135, which may also be referred to as processor 135, may be a processor designed to perform any processing typically requiring specialized processing, such as a neural network processor for use with AI computing tasks such as natural language processing. But while FIG. 1 shows processor 135, embodiments of the disclosure may include any processor 135 that processes data in layers that may be subject to early exit, whether or not using neural networks, and may be used to solve any desired problem, whether or not natural language processing. For example, embodiments of the disclosure may include AI processor 135 designed to use a transfer model with repetitions for image processing.

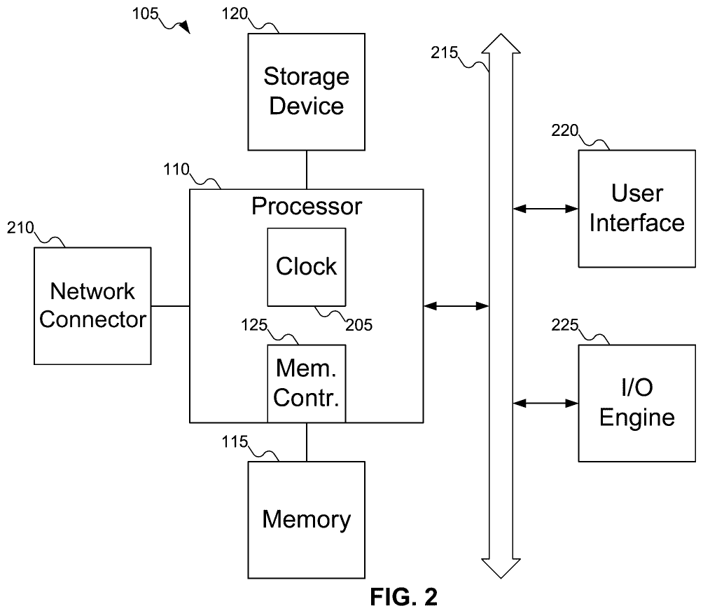

FIG. 2 shows details of the machine of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

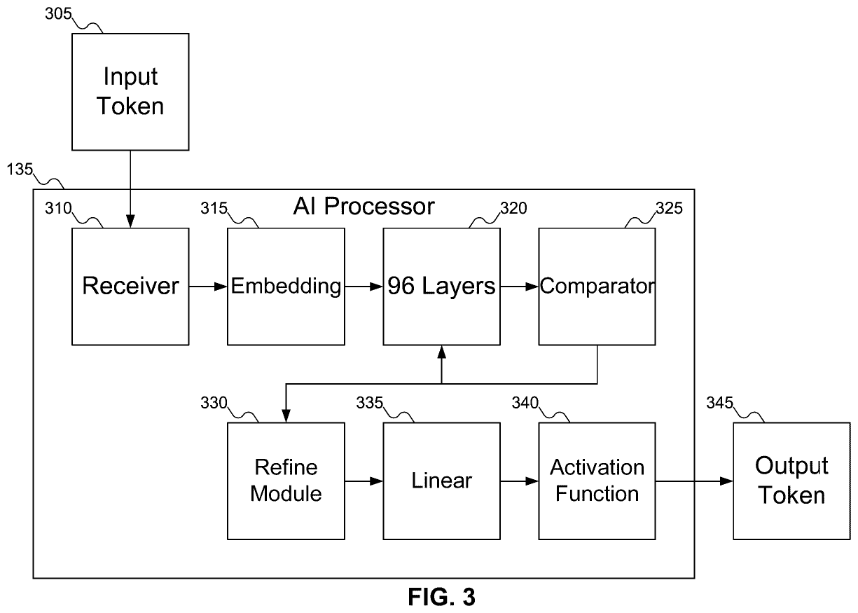

FIG. 3 shows details of AI processor 135 of FIG. 1, according to embodiments of the disclosure. In FIG. 3, AI processor 135 may receive input token 305 using receiver 310. Input token 305 may then be converted into a vector using embedding 315. Once input token 305 has been transformed into a vector, layers 320, which form the heart of AI processor 135, may begin to process the vector. Each layer 320 may process the vector into a new vector, which may then be passed to the next layer 320 in turn.

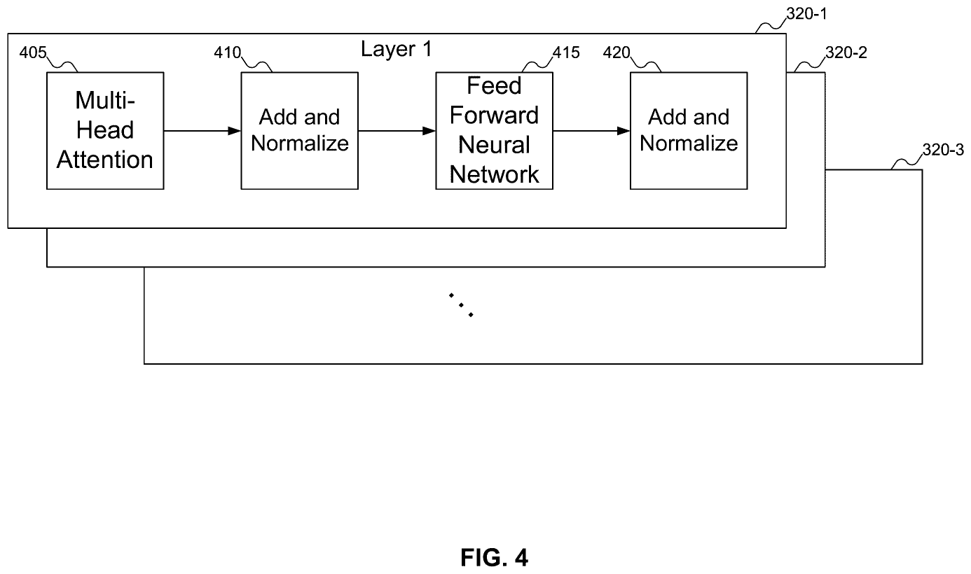

FIG. 4 shows details of layers 320 of FIG. 3, according to embodiments of the disclosure. In FIG. 4, layer 320-1 may include multi-head attention 405, add and normalize unit 410, feed forward neural network 415, and another add and normalize unit 420. Multi-head attention 405 may attempt to understand the meaning of each token considering its relation to other tokens. In this way, the exact meaning of each token and its dependency may be determined from the model. Add and normalize unit 410 may add the features and their normalized values. Feed forward neural network 415 may project the input vector into a higher-dimensional space so the model may more easily capture the complex patterns or features of each token. Then, feed forward neural network 415 may project the vector back to original space. Add and normalize unit 420 may then connect the two vectors (before and after feed forward neural network 415). Similarly to add and normalize unit 410, add and normalize unit 420 may help stabilize the model.

The output of layer 320-1 may then feed into layer 320-2, and so on until layer 320-3, the 96^{th} layer, has processed the vector, at which point processing by layers 320 is complete. By iteratively using layers 320 for some number of iterations—for example, GPT3 may use 96 layers—the model may determine a better understanding of the representation of the current token from the context of the given prompt.

Multi-head attention 405, add and normalize units 410 and 420, and feed forward neural network 415 essentially perform matrix or vector arithmetic, including addition, multiplication, and division, and may be implemented using any desired computing device, such as CPUs, FPGAs, ASICs, SoCs, GPUs, GPGPUs, NPUs, or TPUs, among other possibilities. Further, each element shown in FIG. 4 may be implemented using a different approach, allowing for combining multiple different implementations.

Returning to FIG. 3, comparator 325 may compare the output vectors from layers 320 to see how similar they are. If the output vectors of two consecutive layers 320 are sufficiently similar (or if all 96 layers 320 have been used), then comparator 325 may pass control to refine module 330; otherwise, comparator 325 may return control to the next layer 320. Comparator 325 is discussed further with reference to FIG. 7 below. While FIG. 3 shows layers 320 as including 96 layers, embodiments of the disclosure may include any number of layers 320, of which 96 is merely an example count.

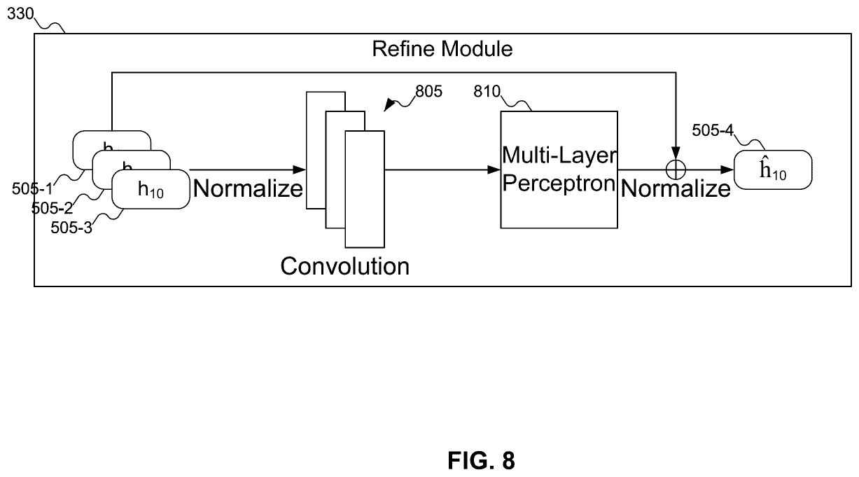

Refine module 330 may then refine the vector provided to it and may refine it. Refine module 330 may make the vector provided to it more accurate, so that the data is more useful. Refine module 330 is discussed further with reference to FIG. 8 below. The data may then be processed by linear module 335 and activation function 340, which may be, for example, a SoftMax function. The output of activation function 340 may then be output token 345, which may be returned from AI processor 135 to be put to whatever use is intended.

FIGS. 3-4 illustrate a particular example use of AI processor 135 of FIG. 1, designed to perform text generation. Linear module 335 and activation function 340 may be applicable to text generation rather than to other forms of AI. Similarly, the implementation of individual layers 320 as shown in FIG. 4 may be applicable to text generation rather than to other forms of AI. Embodiments of the disclosure may be applicable to tasks other than text generation, and may include alternative implementations of layers 320 and/or alternatives to linear module 335 and activation function 340 (and possibly more or fewer such modules) appropriate to the type of AI being implemented.

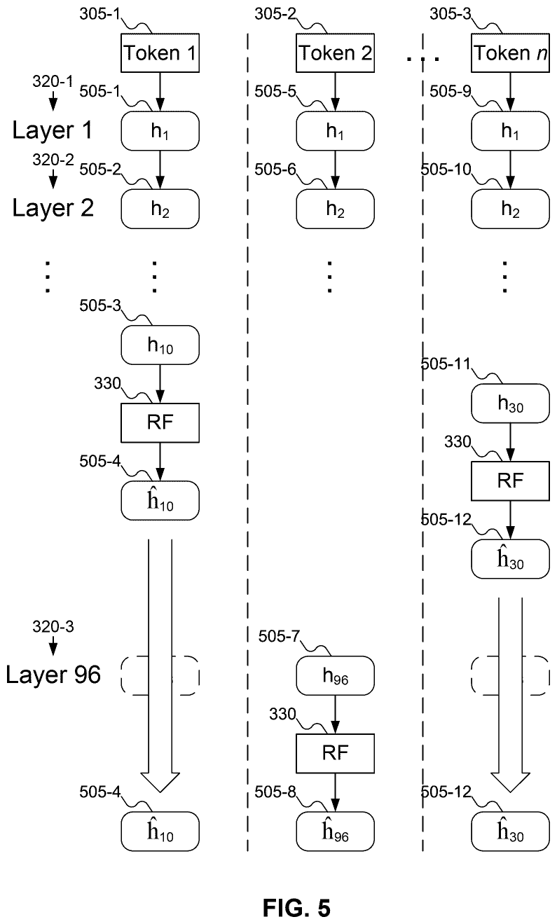

FIG. 5 shows an example of how the use of AI processor 135 of FIG. 1 may be subject to early exit, according to embodiments of the disclosure. In FIG. 5, various tokens 305-1, 305-2, and 305-3 are fed to AI processor 135 of FIG. 1 in turn. For example, token 305-1 may be used (after being transformed into a vector) as input to layer 320-1, which may return vector 505-1 as an intermediary result. Vector 505-1 may be provided as input to layer 320-2, which may return vector 505-2 as an intermediary result, and so on.

At some point, comparator 325 of FIG. 3 may determine that two vectors 505 output by consecutive layers 320 are sufficiently similar that there is little benefit to additional processing. For example, for input token 305-1, comparator 325 of FIG. 3 may determine that vector 505-3 is sufficiently similar to the vector before after processing by 10 layers 320 it that there is little benefit to added processing. Thus, refine module 330 may be applied to vector 505-3 to produce the approximate final vector 505-4, bypassing all the remaining layers 320.

Input token 305-2 may similarly be converted to an initial vector, which may be processed by layer 320-1 to produce vector 505-5, which may then be processed by layer 320-2 to produce vector 505-6, and so on. In the case of input token 305-2, comparator 325 of FIG. 3 may determine that each vector is sufficiently different from its predecessor that processing using layers 320 needs to continue, until finally vector 505-7 is produced by the final layer 320-3. But even though processing of input token 305-2 goes through all 96 layers 320, vector 505-7 produced by layer 320-3 may still be sent through refine module 330 for additional processing to produce approximate final vector 505-8.

Finally, input token 305-3 may similarly be converted to an initial vector, which may be processed by layer 320-1 to produce vector 505-9, which may then be processed by layer 320-2 to produce vector 505-10, and so on. Comparator 325 of FIG. 3 may determine that vector 505-11 is sufficiently similar to the vector before after processing by 30 layers 320 it that there is little benefit to added processing. Thus, refine module 330 may be applied to vector 505-11 to produce the approximate final vector 505-12, bypassing all the remaining layers 320.

Note that each token 305 may be processed separately, and may be processed by varying number of layers 320 as appropriate for input tokens 305. Thus, input token 305-1 was processed by 10 layers 320, input token 305-2 was processed by all 96 layers 320, and input token 305-3 was processed by 30 layers 320. Whether early exit is appropriate may depend on input token 305, as different input tokens 305 may require different degrees of processing.

Note, too, that while intermediate vectors 505-1, 505-5, and 505-9 (all outputs of layer 320-1 for different input tokens 305) are all labeled “h₁”, it should not be concluded that intermediate vectors 505-1, 505-5, and 505-9 are all identical. The labels used for intermediate vectors 505-1, 505-5, and 505-9 should be understood as identifying the outputs of layer 320-1 for different input tokens 305: the coordinates of the actual vectors themselves may differ. Thus, the labels h; that are output from layers 320 are merely names for the vectors produced by layers 320, and should not be understood as suggesting that each layer 320 always produces the same output vector 505 regardless of input token 320.

While the above description suggests that comparator 325 of FIG. 3 compares each vector with the vector from the layer before it, in other embodiments of the disclosure the vector coming out of each layer may be compared instead with a cumulative history vector h_{history}. This cumulative history vector h_{history} may be determined as some aggregation of the intermediate vectors h; from some or all of the previous layers. Thus, for example, in processing token 305-1, after layer 320-2, h_{history} may factor in both vectors 505-1 and 505-2, after layer 320-3, h_{history} may factor in all vectors 505-2, 505-3, and the result of layer 320-3, and so on. In some embodiments of the disclosure, after layer l h_{history} may be determined as h_{history}=Σᵢ₌₁^{l}hᵢ; in other embodiments of the disclosure h_{history} may be determined as a mean of this calculation (that is,

$${h}_{history} = \frac{{\sum }_{i = 1}^{l} {h}_{i}}{l} .$$

For the remainder of this document, any comparison of the output of a layer 505 with the output of a previous layer 505 may also be implemented as a comparison of the output of the layer 505 with the cumulative history vector.

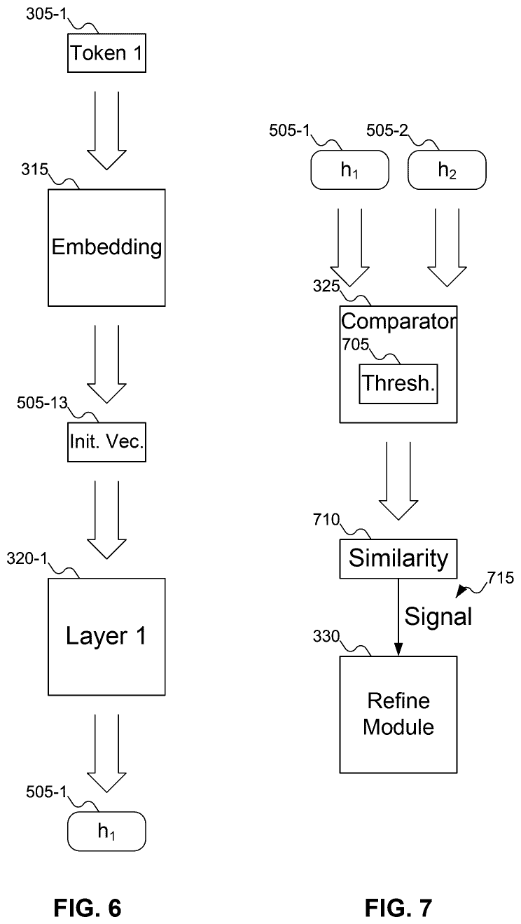

FIG. 6 shows how the initial vector may be generated from input token 305 of FIG. 3, according to embodiments of the disclosure. In FIG. 6, input token 305-1 may be received by AI processor 135 of FIG. 1. Embedding 315 may then generate initial vector 505-13, which may be provided as input to layer 320-1, which may then generate intermediate vector 505-1, as shown in FIG. 5.

FIG. 7 shows details of comparator 325 of FIG. 3, according to embodiments of the disclosure. In FIG. 7, comparator 325 may receive two vectors 505-1 and 505-2, which may be from consecutive layers 320 of FIG. 3. Comparator 325 may determine the similarity between vectors 505-1 and 505-2 by calculating a distance between vectors 505-1 and 505-2 (possibly normalizing vectors 505-1 and 505-2 first). The distance between vectors 505-1 and 505-2 may then be calculated using any desired approach. For example, the distance between vectors 505-1 and 505-2 may be calculated as the Euclidean distance (the square root of the sum of the squares of the differences in the coordinates: if vector 505-1 may be represented as (x₁, x₂, . . . xₙ) and vector 505-2 may be represented as (y₁, y₂, . . . yₙ), then Distance=\sqrt{Σᵢ₌₁ⁿ(xᵢ−yᵢ)²}. Or, the distance between vectors 505-1 and 505-2 may be calculated as the taxicab distance (the sum of the absolute values of the differences in the coordinates: Distance=Σᵢ₌₁ⁿ|xᵢ−yᵢ|. Or, the distance between vectors 505-1 and 505-2 may be calculated using a cosine similarity metric:

$$Distance = \frac{{\sum }_{i = 1}^{n} {x}_{i} \times {y}_{i}}{‖ x ‖ \times ‖ y ‖} ,$$

where ∥v∥ represents the length of the vector v (calculated as ∥v∥=\sqrt{Σᵢ₌₁ⁿxᵢ²}. Other distance equations may also be used in other embodiments of the disclosure.

Once the distance between vectors 505-1 and 505-2 has been calculated, comparator 325 may compare the distance with threshold 705. If the distance is less than threshold 705, then vectors 505-1 and 505-2 may be considered similar; otherwise vectors 505-1 and 505-2 may not be considered similar. Note that embodiments of the disclosure may reverse the significance of threshold 705: if the similarity between vectors 505-1 and 505-2 is greater than threshold 705, then vectors 505-1 and 505-2 may be considered similar, otherwise not.

While the above description focuses on similarity 710 being determined by measuring the distance or angle between vectors 505-1 and 505-2, embodiments of the disclosure may also use other measures of similarity. For example, after each layer 320 of FIG. 3 finishes processing vector 505, a running average of all vectors 505 may be computed. That is, after layer 320-1 of FIG. 3 finishes processing initial vector 505-1 to generate vector 505-2, the running average may be set to the vector 505-2, after layer 320-2 of FIG. 3 finishes processing vector 505-2 to generate vector 505-3 of FIG. 5, the running average may be set to the average of vectors 505-2 and 505-3 of FIG. 5, and so on. Calculating the running average may be done without needing to store every vector 505 (although every vector 505 may be stored). For example, factoring vector 505 into the running average may be done by multiplying the old running average by the number of layers used previously, adding the current vector 505, and then dividing by the number of layers now used.

Once the running average has been computed, the running average may be compared with either the previous running average or the current vector 505. This comparison may be done as discussed above: for example, by calculating the distance between the vectors, by calculating a cosine similarity metric, or by comparing the angle between the vectors. If the distance so calculated is less than threshold 705, then running average may be considered sufficiently similar to either the previous running average or the current vector 505.

In other embodiments of the disclosure, other approaches may be used. For example, rather than comparing vectors 505 that are output by adjacent layers 320 of FIG. 3, comparator 325 may compare vectors 505 output by layers 320 that are farther apart. For example, comparator 325 might compare vectors 505 output by layers 320 that are separated by one, two three, or any number of intervening layers 320.

However similarity 710 is determined based on threshold 705, comparator 325 may send a signal to refine module 330 to calculate the approximate final vector from vector 505-2. (Comparator 325 may also send signal 715 to the next layer 320 of FIG. 3, either to prevent layer 320 of FIG. 3 from processing vector 505-2 or to begin processing of vector 505-2, depending on similarity 710.)

While the above description describes vectors 505-1 and 505-2 as being output from consecutive layers 320 of FIG. 3, in some embodiments of the disclosure comparator 325 might compare vectors 505 output by layers 320 of FIG. 3 that are further away from each other. For example, comparator 325 might compare two vectors 505 from layers 320 of FIG. 3 that are two apart, or three apart, or more. If the output vectors 505 of two layers 320 of FIG. 3 that are two, three, or more layers 320 of FIG. 3 apart from each other are sufficiently similar, then comparator 325 may conclude that only small incremental improvements in vectors 505 are occurring, and early exit from layers 320 of FIG. 3 may be acceptable. Comparator 325 might even perform a pairwise comparing of vectors 505 from every layer 320 of FIG. 3 (which may catch situations where layers 320 of FIG. 3 end up cyclically processing vectors 505: even though each adjacent pair of vectors 505 appear sufficiently dissimilar, eventually a vector 505 may be approximately similar to an earlier vector 505 to justify early exit and abort the unnecessary processing).

FIG. 8 shows details of refine module 330 of FIG. 3, according to embodiments of the disclosure. In FIG. 8, refine module 330 may take various vectors 505 produced by layers 320 of FIG. 3 that have processed input token 305 of FIG. 3 so far. While FIG. 8 shows refine module 330 as taking three vectors 505-1, 505-2, and 505-3 as input, embodiments of the disclosure may include any number of vectors taken as input to refine module 330. Refine module 330 may normalize these vectors, then may perform convolution 805 on these vectors. Once convolution 805 is complete, Multi-Layer Perceptron (MLP) 810 may process the results, which may then be normalized again (and potentially vectors 505 may be factored in as well). The result of this process is approximate final vector 505-4.

Convolution 805 and MLP 810 may involve training. That is, various input vectors 505 may be fed into refine module 330 and processed in various ways, with the preferred output vector 505-4 selected so as to teach refine module 330 how to generate approximate final vector 505-4. Thus, convolution 805 and/or MLP 810 may involve additional neural networks.

While FIG. 8 shows a particular implementation of refine module 330, embodiments of the disclosure may include any desired implementation of refine module 330 that may achieve the desired final vector. Embodiments of the disclosure are intended to include any alternative implementations of refine module 330.

There are other ways in which a similarity check may be performed. For example, each layer 320 of FIG. 3 may be trained for similarity checks. But this approach requires training the original base model, which is a lengthy and expensive process involving billions or more of parameters, and may limit the applicability of AI processor 135 of FIG. 1 to other problems. Another approach may be to add a classifier after each level 320 of FIG. 3 processes the data. The outputs of the classifiers may then be checked for similarity. But because there are 96 layers 320 of FIG. 3, adding classifiers would require adding 96 classifiers. Further, each classifier requires training, involving billions or more of parameters, making the use of classifiers a lengthy and expensive addition. Refine module 330 is relatively smaller and simpler to train than layers 320 of FIG. 3 or classifiers, reducing the training time. And because refine module 330 is used only when vectors 505 are sufficiently similar according to comparator 325 of FIG. 3, computational processing is minimized (as compared, for example, with the classifiers, which are used after every layer 320 of FIG. 3 until the results are considered sufficiently similar).

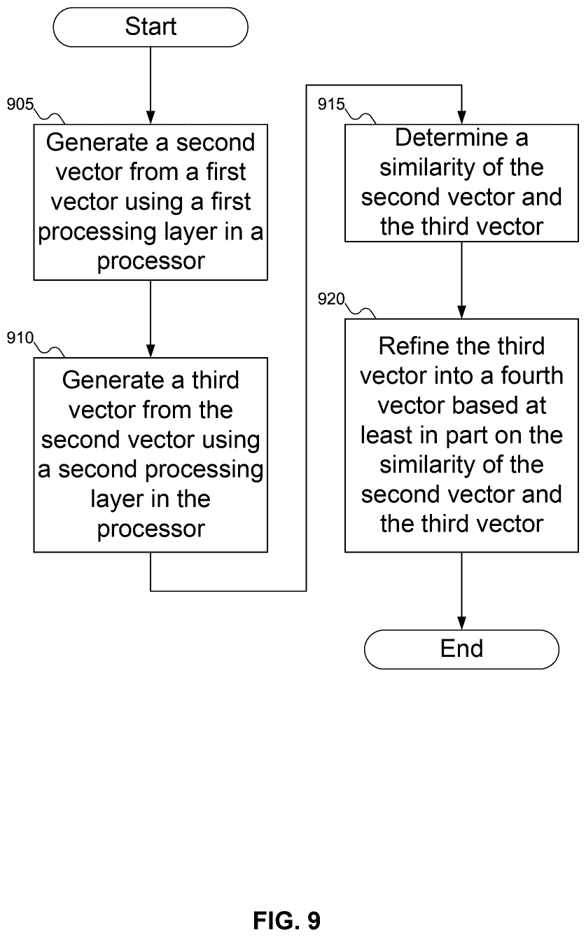

FIG. 9 shows a flowchart of an example procedure for AI processor 135 of FIG. 1 to process data, according to embodiments of the disclosure. In FIG. 9, at block 905, layer 320 of FIG. 3 may generate vector 505-2 of FIG. 5 from vector 505-1 of FIG. 5. At block 910, layer 320 of FIG. 3 may generate vector 505-3 of FIG. 5 from vector 505-2 of FIG. 5. At block 915, comparator 325 of FIG. 3 may determine similarity 710 of FIG. 7 for vectors 505-2 and 505-3 of FIG. 5. Finally, at block 920, refine module 330 of FIG. 3 may refine vector 505-3 of FIG. 5 into vector 505-4 of FIG. 5 based on similarity 710 of FIG. 7 for vectors 505-2 and 505-3 of FIG. 5.

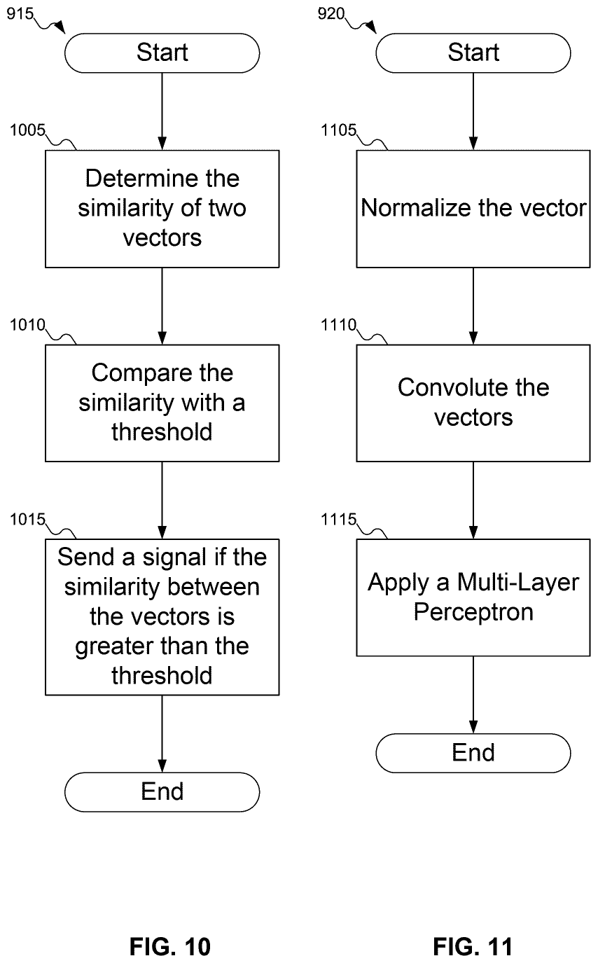

FIG. 10 shows a flowchart of an example procedure for comparator 325 of FIG. 3 determine the similarity of two vectors 505 of FIG. 5, according to embodiments of the disclosure. In FIG. 10, at block 1005, comparator 325 of FIG. 3 may determine similarity 710 of FIG. 7 between two vectors 505 of FIG. 5. At block 1010, comparator 325 of FIG. 3 may compare similarity 710 of FIG. 7 with threshold 705 of FIG. 7 to determine vectors 505 of FIG. 5 are sufficiently similar. Finally, at block 1015, comparator 325 of FIG. 3 may send signal 715 of FIG. 7 if similarity 710 of FIG. 7 exceeds threshold 705 of FIG. 7.

FIG. 11 shows a flowchart of an example procedure for refine module 330 of FIG. 3 approximate the final output of layers 320 of FIG. 3, according to embodiments of the disclosure. In FIG. 11, at block 1105, refine module 330 of FIG. 3 may normalize vectors 505 of FIG. 5. At block 1110, refine module 330 of FIG. 3 may apply convolution 805 of FIG. 8 to normalized vectors 505 of FIG. 5. Finally, at block 1115, refine module 330 of FIG. 3 may apply MLP 810 of FIG. 8.

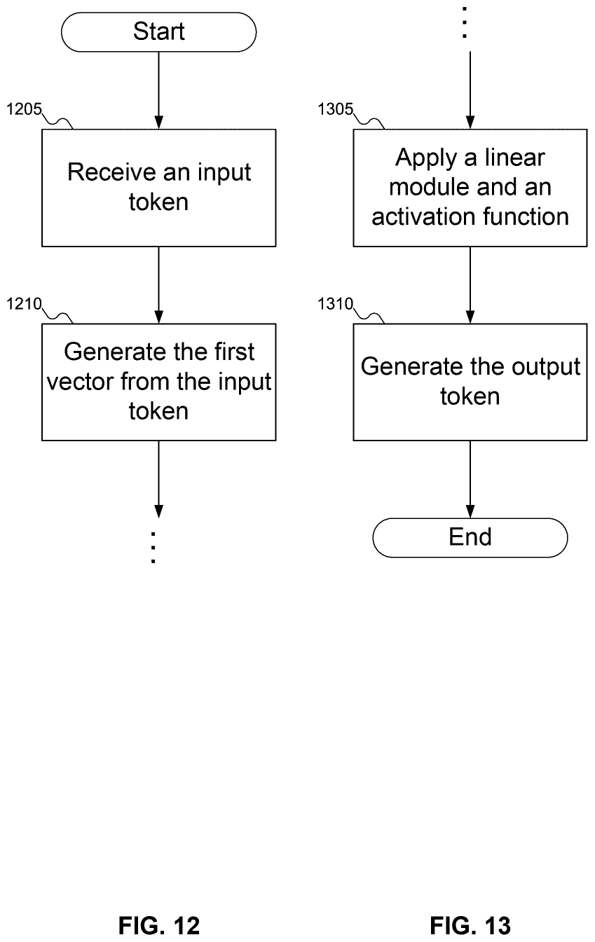

FIG. 12 shows a flowchart of an example procedure for AI processor 135 of FIG. 1 to begin processing input token 305 of FIG. 3, according to embodiments of the disclosure. In FIG. 12, at block 1205, receiver 310 of FIG. 3 may receive input token 305 of FIG. 3. At block 1210, embedding 315 of FIG. 3 may convert input token 305 of FIG. 3 into initial vector 505 of FIG. 5.

FIG. 13 shows a flowchart of an example procedure for AI processor 135 of FIG. 1 to generate output token 345 of FIG. 3, according to embodiments of the disclosure. In FIG. 13, at block 1305, AI processor 135 of FIG. 1 may apply linear module 335 and activation function 340 of FIG. 3. As a result, at block 1310, output token 345 of FIG. 3 may be generated.

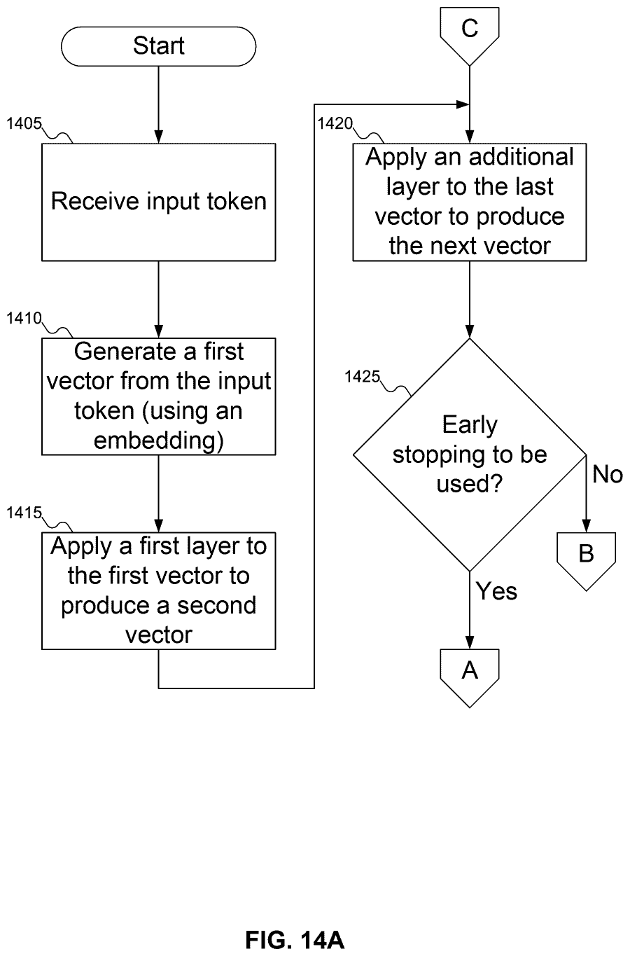

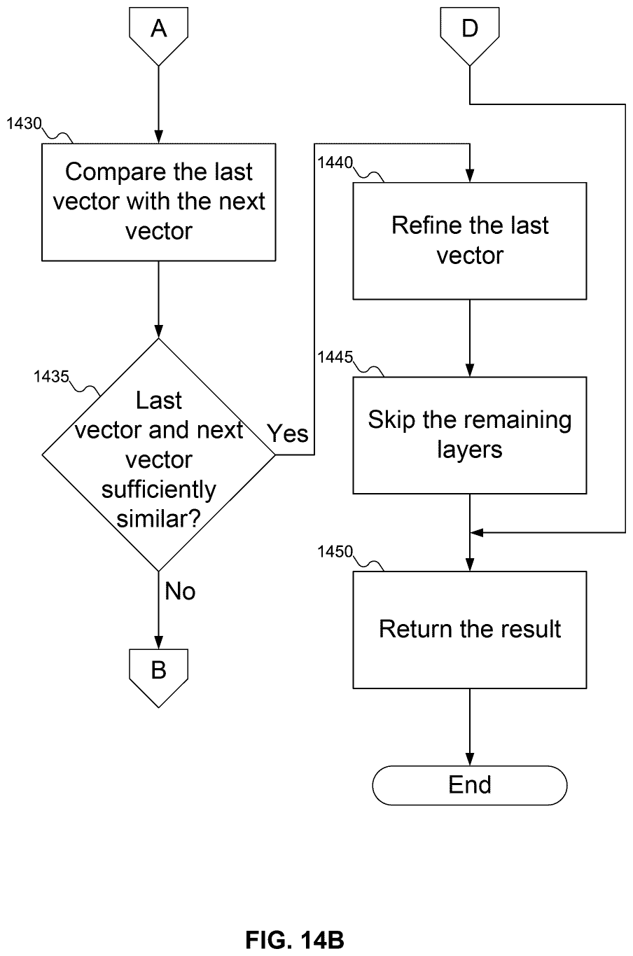

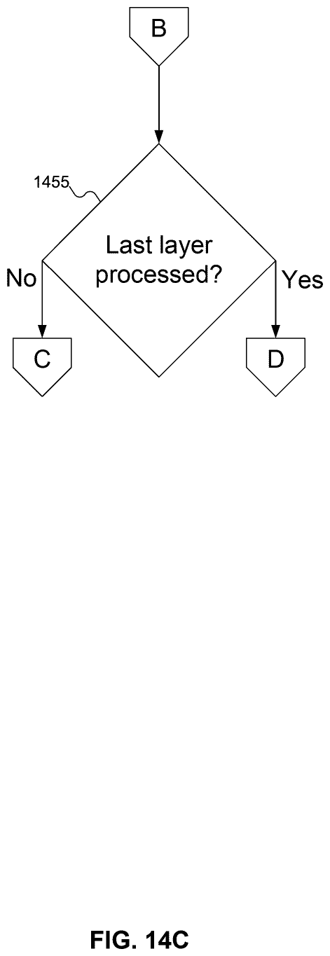

FIGS. 14A-14C show a flowchart of an example procedure for AI processor 135 of FIG. 1 to process data, according to embodiments of the disclosure. FIGS. 14A-14C show how the various elements/flowcharts of the disclosure may work as a whole. In FIG. 14A, at block 1405, receiver 310 of FIG. 3 may receive input token 305 of FIG. 3. At block 1410, embedding 315 of FIG. 3 may convert input token 305 of FIG. 3 into initial vector 505-1 of FIG. 5.

At block 1415, layer 320 of FIG. 3 may generate vector 505-2 of FIG. 5 from initial vector 505-1 of FIG. 5. At block 1420, layer 320 of FIG. 3 may generate vector 505-3 of FIG. 5 from vector 505-2 of FIG. 5. At block 1425, AI processor 135 of FIG. 1 may determine if early stopping is to be used (as early stopping may be omitted and complete processing of input token 305 of FIG. 3 may be performed using all layers 320 of FIG. 3).

If initial stopping is to be used, then at block 1430 (FIG. 14B), comparator 325 of FIG. 3 may compare vector 505-3 of FIG. 5 with vector 505-2 of FIG. 5. At block 1435, if vectors 505-2 and 505-3 of FIG. 5 are sufficiently similar, then at block 1440, refine module 330 of FIG. 3 may refine vector 505-3 of FIG. 5 into vector 505-4 of FIG. 5. At block 1445 any remaining layers 320 of FIG. 3 may be skipped, and at block 1450 vector 505-4 of FIG. 5 may be returned from AI processor 135 of FIG. 1.

If initial stopping is not used, or if vectors 505-2 and 505-3 of FIG. 5 are not sufficiently similar, then at block 1455 (FIG. 14C), AI processor 135 of FIG. 1 may determine if the last layer 320 of FIG. 3 has been used to process input token 305 of FIG. 3. If not, then processing may continue with block 1420 of FIG. 14A to use another layer 320 of FIG. 3 to process vector 505-3 of FIG. 5. Otherwise, all layers 320 of FIG. 3 have been used to process input token 305, and processing may continue with block 1450 to return vector 505-4 of FIG. 5 from AI processor 135 of FIG. 1.

In FIGS. 9-14C, some embodiments of the disclosure are shown. But a person skilled in the art will recognize that other embodiments of the disclosure are also possible, by changing the order of the blocks, by omitting blocks, by including links not shown in the drawings, or by adding blocks appropriate to existing layers or operations of deep neural networks. All such variations of the flowcharts are considered to be embodiments of the disclosure, whether expressly described or not.

Embodiments of the disclosure may include an early exit logic for an AI processor. After a layer has processed a vector, a comparator may compare that vector with its predecessor. If the vectors are sufficiently similar, then processing of any remaining layers in the AI processor may be bypassed. The vector may be provided to a refine module to generate an approximate final output vector. The refine module may be trained to produce the approximate final output vector. This structure offers a technical advantage in reducing the amount of training needed to determine when to exit processing early, and minimizes additional processing as the refine module is used when the vectors are already sufficiently similar rather than being used at every layer.

Generative Artificial Intelligence (AI) has been of great interest to academia and industry, creating a new business model. The size of underlying AI models that power such systems is increasing, which results in high computational complexity to execute designated operations during inference of large AI models. Large AI models may repeatedly use a certain structure (such as multi-head attention blocks or residual blocks, among other possibilities).

For example, transformer models may include a series (for example, 96) of identical blocks. The depth of this series may determine the quality. Advanced models may include more blocks for the quality, but the fixed number of block iterations may be in excess of the number necessary for simple tasks. Such models may result in loss of time, power, and/or efficiency.

Embodiments of the disclosure attempt to reduce the computational requirements for efficient AI model inference by reducing the use of repeated blocks to achieve faster inference, computational efficiency, enhanced latency, and reduced power consumption. Embodiments of the disclosure may perform a number of iterations that may adapt to or depend on the difficulty of the task. Embodiments of the disclosure may support adaptive iterations for general purposes of transformer models or other models of AI. Embodiments of the disclosure may therefore save power/latency by eliminating redundancy and may increase the average throughput.

Embodiments of the disclosure may remove computation nodes without sacrificing the accuracy of the AI model. At inference time, after computing operations of each block, the output hidden state is compared with that of the previous block (or a cumulative history state) to measure how similar they are. If the output hidden state of the two blocks are sufficiently similar, early stopping of computation may be performed. Once early stopping is activated with high similarity, the current hidden state is further refined while skipping all computations of the rest blocks. The refined hidden state may be considered as the final output of the AI model, and may be used to decode task-specific results such as generated text, reconstructed image, classified category, and regressed values. Embodiments of the disclosure are generally applicable to any existing AI models (e.g., Large Language Modules (LLMs), Vision Transformers (ViT), other Transformers or convolutions, etc.), but may be most effective when it used large AI models.

By controlling the threshold used for early stopping, the neural network performance may be controlled. Any neural network may use this early-stopping approach. Early stopping may improve power consumption, may provide a performance boost without additional training of the base model, and may require less trainable parameters than the base model.

Embodiments of the disclosure may be used, among other possibilities, for transformer models for inference or to optimize domain-specific transformer models.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Embodiments of the disclosure may extend to the following statements, without limitation:
Statement 1. An embodiment of the disclosure includes a processor, comprising:
   a first processing layer to process a first vector into a second vector;
   a second processing layer to process the second vector into a third vector;
   a comparator to determine a similarity of the third vector and a fourth vector; and
   a refine module to refine the third vector into a fifth vector based at least in part on the similarity of the third vector and the fourth vector.
Statement 2. An embodiment of the disclosure includes the processor according to statement 1, wherein the fourth vector includes the second vector.
Statement 3. An embodiment of the disclosure includes the processor according to statement 1, further comprising a third processing layer to process the third vector into the fourth vector.
Statement 4. An embodiment of the disclosure includes the processor according to statement 1, wherein:
   the processor further comprises a third processing layer to process the third vector into a fifth vector; and
   the fourth vector is based at least in part on the second vector and the fifth vector.
Statement 5. An embodiment of the disclosure includes the processor according to statement 1, wherein the fourth vector includes an aggregation of at least the first vector and the second vector.
Statement 6. An embodiment of the disclosure includes the processor according to statement 1, wherein the first processing layer and the second processing layer do not need to be trained for the comparator or the refine module.
Statement 7. An embodiment of the disclosure includes the processor according to statement 1, wherein the first processing layer and the second processing layer do not each need a classifier.
Statement 8. An embodiment of the disclosure includes the processor according to statement 1, wherein the refine module is configured to be trained to refine the third vector into the fifth vector.
Statement 9. An embodiment of the disclosure includes the processor according to statement 1, wherein the comparator is configured to generate a signal based at least in part on the similarity of the third vector and the fourth vector exceeding a threshold.
Statement 10. An embodiment of the disclosure includes the processor according to statement 9, wherein the refine module is configured to receive the signal and to refine the third vector into the fifth vector based at least in part on the signal.
Statement 11. An embodiment of the disclosure includes the processor according to statement 1, further comprising a third processing layer to process the third vector into a sixth vector based at least in part on the similarity of the third vector and the fourth vector.
Statement 12. An embodiment of the disclosure includes the processor according to statement 11, wherein the third processing layer is configured to process the third vector into the sixth vector based at least in part on a lack of the similarity of the third vector and the fourth vector.
Statement 13. An embodiment of the disclosure includes the processor according to statement 1, wherein the refine module includes a convolution and a Multi-Layer Perceptron (MLP).
Statement 14. An embodiment of the disclosure includes the processor according to statement 13, wherein the convolution includes the third vector and the fourth vector.
Statement 15. An embodiment of the disclosure includes the processor according to statement 14, wherein the fourth vector includes the second vector.
Statement 16. An embodiment of the disclosure includes the processor according to statement 14, wherein the convolution further includes a sixth vector.
Statement 17. An embodiment of the disclosure includes the processor according to statement 16, wherein the sixth vector is generated using a fourth processing layer in the processor.
Statement 18. An embodiment of the disclosure includes the processor according to statement 13, wherein the refine module is configured to normalize an output of the MLP.
Statement 19. An embodiment of the disclosure includes the processor according to statement 1, further comprising a third processing layer to process the third vector into a sixth vector is not used based at least in part on the similarity of the third vector (505 and the fourth vector.
Statement 20. An embodiment of the disclosure includes the processor according to statement 1, further comprising:
   a receiver to receive an input token; and
   an embedding to generate the first vector from the input token.
Statement 21. An embodiment of the disclosure includes the processor according to statement 1, further comprising:
   a third processing layer to process the third vector into a sixth vector; and
   a decoder to generate an output token from the fifth vector or the sixth vector.
Statement 22. An embodiment of the disclosure includes the processor according to statement 21, wherein the decoder includes a linear module and an activation function.
Statement 23. An embodiment of the disclosure includes the processor according to statement 22, wherein the activation function includes a SoftMax function.
Statement 24. An embodiment of the disclosure includes a method, comprising:
   generating a second vector from a first vector using a first processing layer in a processor;
   generating a third vector from the second vector using a second processing layer in the processor;
   determining a similarity of the third vector and a fourth vector; and
   refining the third vector into a fifth vector based at least in part on the similarity of the third vector and the fourth vector.
Statement 25. An embodiment of the disclosure includes the method according to statement 24, wherein the fourth vector includes the second vector.
Statement 26. An embodiment of the disclosure includes the method according to statement 24, further comprising generating the fourth vector from the third vector using a third processing layer in the processor.
Statement 27. An embodiment of the disclosure includes the method according to statement 24, wherein:
   the method further comprises generating a sixth vector from the third vector using a third processing layer in the processor; and
   the fourth vector is based at least in part on the second vector and the sixth vector.
Statement 28. An embodiment of the disclosure includes the method according to statement 24, wherein the fourth vector includes an aggregation of at least the first vector and the second vector.
Statement 29. An embodiment of the disclosure includes the method according to statement 24, wherein refining the third vector into the fifth vector based at least in part on the similarity of the third vector and the fourth vector includes:
   convoluting the third vector and the fourth vector; and
   applying a Multi-Layer Perceptron (MLP).
Statement 30. An embodiment of the disclosure includes the method according to statement 29, wherein the fourth vector includes the second vector.
Statement 31. An embodiment of the disclosure includes the method according to statement 29, wherein convoluting the second vector and the third vector includes convoluting the second vector, the third vector, and a sixth vector.
Statement 32. An embodiment of the disclosure includes the method according to statement 31, wherein the sixth vector is generated using a third processing layer in the processor.
Statement 33. An embodiment of the disclosure includes the method according to statement 24, wherein determining a similarity of the third vector and the fourth vector includes comparing the third vector and the fourth vector with a threshold.
Statement 34. An embodiment of the disclosure includes the method according to statement 33, wherein comparing the third vector and the fourth vector with the threshold includes:
   determining a difference between the third vector and the fourth vector; and
   comparing the difference with the threshold.
Statement 35. An embodiment of the disclosure includes the method according to statement 24, wherein:
   determining the similarity of the third vector and the fourth vector includes sending a signal to a refine module about the similarity of the third vector and the fourth vector; and
   refining the third vector into the fifth vector based at least in part on the similarity of the third vector and the fourth vector includes refining the third vector into the fifth vector based at least in part on the signal.
Statement 36. An embodiment of the disclosure includes the method according to statement 24, further comprising generating a sixth vector from the third vector using a third processing layer in the processor based at least in part on the similarity of the third vector and the fourth vector.
Statement 37. An embodiment of the disclosure includes the method according to statement 36, wherein generating the sixth vector from the third vector using a third processing layer in the processor based at least in part on the similarity of the third vector and the fourth vector includes generating the sixth vector from the third vector using a third processing layer in the processor based at least in part on a lack of the similarity of the third vector and the fourth vector.
Statement 38. An embodiment of the disclosure includes the method according to statement 24, wherein the first processing layer and the second processing layer do not need to be trained to support determining the similarity of the third vector and the fourth vector.
Statement 39. An embodiment of the disclosure includes the method according to statement 24, wherein refining the third vector into the fifth vector based at least in part on the similarity of the third vector and the fourth vector includes normalizing the fifth vector.
Statement 40. An embodiment of the disclosure includes the method according to statement 24, further comprising:
   receiving an input token; and
   generating the first vector from the input token.
Statement 41. An embodiment of the disclosure includes the method according to statement 40, wherein generating the first vector from the input token includes generating the first vector from the input token using an embedding.
Statement 42. An embodiment of the disclosure includes the method according to statement 24, further comprising generating an output token from the fifth vector.
Statement 43. An embodiment of the disclosure includes the method according to statement 42, wherein generating the output token from the fifth vector includes applying a linear module and an activation function.
Statement 44. An embodiment of the disclosure includes the method according to statement 43, wherein the activation function includes a SoftMax function.
Statement 45. An embodiment of the disclosure includes an system, comprising a non-transitory storage medium, the non-transitory storage medium having stored thereon instructions that, when executed by a machine, result in:
   generating a second vector from a first vector using a first processing layer in a processor;
   generating a third vector from the second vector using a second processing layer in the processor;
   determining a similarity of the third vector and a fourth vector; and
   refining the third vector into a fifth vector based at least in part on the similarity of the third vector and the fourth vector.
Statement 46. An embodiment of the disclosure includes the system according to statement 45, wherein the fourth vector includes the second vector.
Statement 47. An embodiment of the disclosure includes the system according to statement 45, wherein the fifth vector includes an aggregation of at least the first vector and the second vector.
Statement 48. An embodiment of the disclosure includes the system according to statement 45, the non-transitory storage medium having stored thereon further instructions that, when executed by the machine, result in generating the fourth vector from the third vector using a third processing layer in the processor.
Statement 49. An embodiment of the disclosure includes the system according to statement 45, wherein:
   the non-transitory storage medium has stored thereon further instructions that, when executed by the machine, result in generating a sixth vector from the third vector using a third processing layer in the processor; and
   the fourth vector is based at least in part on the second vector and the sixth vector.
Statement 50. An embodiment of the disclosure includes the system according to statement 45, wherein refining the third vector into the fifth vector based at least in part on the similarity of the third vector and the fourth vector includes:
   convoluting the third vector and the fourth vector; and
   applying a Multi-Layer Perceptron (MLP).
Statement 51. An embodiment of the disclosure includes the system according to statement 50, wherein the fourth vector includes the second vector.
Statement 52. An embodiment of the disclosure includes the system according to statement 50, wherein convoluting the second vector and the third vector includes convoluting the second vector, the third vector, and a sixth vector.
Statement 53. An embodiment of the disclosure includes the system according to statement 52, wherein the sixth vector is generated using a third processing layer in the processor.
Statement 54. An embodiment of the disclosure includes the system according to statement 45, wherein determining a similarity of the third vector and the fourth vector includes comparing the third vector and the fourth vector with a threshold.
Statement 55. An embodiment of the disclosure includes the system according to statement 54, wherein comparing the third vector and the fourth vector with the threshold includes:
   determining a difference between the third vector and the fourth vector; and
   comparing the difference with the threshold.
Statement 56. An embodiment of the disclosure includes the system according to statement 45, wherein:
   determining the similarity of the third vector and the fourth vector includes sending a signal to a refine module about the similarity of the third vector and the fourth vector; and
   refining the third vector into the fifth vector based at least in part on the similarity of the third vector and the fourth vector includes refining the third vector into the fifth vector based at least in part on the signal.
Statement 57. An embodiment of the disclosure includes the system according to statement 45, the non-transitory storage medium having stored thereon further instructions that, when executed by the machine, result in generating a sixth vector from the third vector using a third processing layer in the processor based at least in part on the similarity of the third vector and the fourth vector.
Statement 58. An embodiment of the disclosure includes the system according to statement 57, wherein generating the sixth vector from the third vector using a third processing layer in the processor based at least in part on the similarity of the third vector and the fourth vector includes generating the sixth vector from the third vector using a third processing layer in the processor based at least in part on a lack of the similarity of the third vector and the fourth vector.
Statement 59. An embodiment of the disclosure includes the system according to statement 45, wherein the first processing layer and the second processing layer do not need to be trained to support determining the similarity of the third vector and the fourth vector.
Statement 60. An embodiment of the disclosure includes the system according to statement 45, wherein refining the third vector into the fifth vector based at least in part on the similarity of the third vector and the fourth vector includes normalizing the fifth vector.
Statement 61. An embodiment of the disclosure includes the system according to statement 45, the non-transitory storage medium having stored thereon further instructions that, when executed by the machine, result in:
   receiving an input token; and
   generating the first vector from the input token.
Statement 62. An embodiment of the disclosure includes the system according to statement 61, wherein generating the first vector from the input token includes generating the first vector from the input token using an embedding.
Statement 63. An embodiment of the disclosure includes the system according to statement 45, the non-transitory storage medium having stored thereon further instructions that, when executed by the machine, result in generating an output token from the fifth vector.
Statement 64. An embodiment of the disclosure includes the system according to statement 63, wherein generating the output token from the fifth vector includes applying a linear module and an activation function.
Statement 65. An embodiment of the disclosure includes the system according to statement 64, wherein the activation function includes a SoftMax function.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A processor, comprising:
a first processing layer to process a first vector into a second vector;
a second processing layer to process the second vector into a third vector;
a comparator to determine a similarity of the third vector and a fourth vector; and
a refine module to refine the third vector into a fifth vector based at least in part on the similarity of the third vector and the fourth vector.

2. The processor according to claim 1, further comprising a third processing layer to process the third vector into the fourth vector.

3. The processor according to claim 1, wherein the refine module is configured to be trained to refine the third vector into the fifth vector.

4. The processor according to claim 1, further comprising a third processing layer to process the third vector into a sixth vector based at least in part on the similarity of the third vector and the fourth vector.

5. The processor according to claim 1, wherein the refine module includes a convolution and a Multi-Layer Perceptron (MLP).

6. The processor according to claim 5, wherein the convolution further includes a sixth vector.

7. The processor according to claim 6, wherein the sixth vector is generated using a fourth processing layer in the processor.

8. The processor according to claim 5, wherein the refine module is configured to normalize an output of the MLP.

9. The processor according to claim 1, further comprising:
a receiver to receive an input token; and
an embedding to generate the first vector from the input token.

10. The processor according to claim 1, further comprising a linear module and an activation function to generate an output token from the fourth vector or the fifth vector.

11. A method, comprising:
generating a second vector from a first vector using a first processing layer in a processor;
generating a third vector from the second vector using a second processing layer in the processor;
determining a similarity of the third vector and a fourth vector; and
refining the third vector into a fifth vector based at least in part on the similarity of the third vector and the fourth vector.

12. The method according to claim 11, further comprising generating the fourth vector from the third vector using a third processing layer in the processor.

13. The method according to claim 11, wherein refining the third vector into the fourth vector based at least in part on the similarity of the second vector and the third vector includes:
convoluting the third vector and the fourth vector; and
applying a Multi-Layer Perceptron (MLP).

14. The method according to claim 11, wherein determining a similarity of the third vector and the fourth vector includes comparing the third vector and the fourth vector with a threshold.

15. The method according to claim 14, wherein comparing the third vector and the fourth vector with the threshold includes:
determining a difference between the third vector and the fourth vector; and
comparing the difference with the threshold.

16. The method according to claim 11, wherein:
determining the similarity of the third vector and the fourth vector includes sending a signal to a refine module about the similarity of the third vector and the fourth vector; and
refining the third vector into the fifth vector based at least in part on the similarity of the third vector and the fourth vector includes refining the third vector into the fifth vector based at least in part on the signal.

17. The method according to claim 11, further comprising generating a sixth vector from the third vector using a third processing layer in the processor based at least in part on the similarity of the third vector and the fourth vector.

18. The method according to claim 11, further comprising:
receiving an input token; and
generating the first vector from the input token using an embedding.

19. An article, comprising a non-transitory storage medium, the non-transitory storage medium having stored thereon instructions that, when executed by a machine, result in:
generating a second vector from a first vector using a first processing layer in a processor;
generating a third vector from the second vector using a second processing layer in the processor;
determining a similarity of the third vector and a fourth vector; and
refining the third vector into a fifth vector based at least in part on the similarity of the third vector and the fourth vector.

20. The article according to claim 19, wherein refining the third vector into the fifth vector based at least in part on the similarity of the third vector and the fourth vector includes:
convoluting the third vector and the fourth vector; and
applying a Multi-Layer Perceptron (MLP).
